(19) United States
(12) Patent Application Publication
(10) Pub. No.: US 2026/0280108 A1
(43) Pub. Date: Sep. 17, 2026

(54) ANTENNA DEVICE AND ELECTRONIC DEVICE USING THE SAME

(71) Applicant: Getac Technology Corporation, New Taipei City (TW)

(72) Inventors: Min Yu WANG, Taipei City (TW); Kun-Cheng LEE, Taipei City (TW); Jia-Min HUANG, Taipei City (TW)

(21) Appl. No.: 19/319,927

(22) Filed: Sep. 5, 2025

(30) Foreign Application Priority Data
Mar. 13, 2025 (TW) 114109421

(51) Int. Cl. H01Q 1/36; H01Q 1/22; H01Q 1/48

(52) U.S. Cl. CPC H01Q 1/362; H01Q 1/22; H01Q 1/48

(57) ABSTRACT

The antenna device includes a substrate, a first helical antenna, a second helical antenna and a first support member. A first end of the first helical antenna is coupled to the substrate and electrically connected to a ground terminal. A first end of the second helical antenna is coupled to the substrate and electrically connected to a signal feeding terminal. The first support member is coupled to the substrate. A second support member is disposed in the first support member. The first helical antenna is disposed around an outer surface of the first support member. The second helical antenna is disposed between the inner surface of the first support member and the second support member.

### RELATED APPLICATIONS

This is a U.S. Application, which claims priority to Taiwan Application Serial Number 114109421, filed Mar. 13, 2025, which is herein incorporated by reference.

### BACKGROUND

### Field of Disclosure

The present disclosure relates to an antenna device, and more particularly to an antenna device having a helical antenna.

### Description of Related Art

In general, wireless radio frequency signals are capable of exhibiting characteristics of linear polarization or circular polarization and therefore are designed to do so as needed. For example, according to the specifications of global positioning systems (GPS), all electromagnetic waves for use in defining a GPS-oriented positioning signal usually exhibit circular polarization characteristics. To receive a positioning signal with circular polarization characteristics, an antenna disposed at a receiving end for the positioning signal is a patch antenna or helical antenna. Typically, helical antennas have larger bandwidths. Therefore, helical antennas are generally more suitable for receiving GPS signals than patch antennas.

However, due to the shape and structure of helical antennas being inherently susceptible to external forces, they are prone to deformation. During the assembly process of the helical antennas and the electronic devices or the transportation process of the assembled electronic devices, the helical antennas are usually deformed by being pressed or impacted from external force. The structural parameters of the helical antenna such as the vertical separation or the pitch angle are changed when the structures of helical antenna are deformed, consequently impacting the quality of its signal transmission and reception.

Therefore, how to prevent the helical antenna from deforming due to external forces and affecting the structural parameters of the helical antenna is an urgent problem that the industry needs to solve.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure.

One embodiment of the present disclosure is to provide an antenna device. The antenna device includes a substrate, a first helical antenna, a second helical antenna and a first support member. A first end of the first helical antenna is coupled to the substrate and electrically connected to a ground terminal. A first end of the second helical antenna is coupled to the substrate and electrically connected to a signal feeding terminal. The first support member is coupled to the substrate, and a second support member is arranged at the center of the first support member. The first helical antenna is arranged around an outer surface of the first support member, and the second helical antenna is arranged between the inner surface of the first support member and the second support member.

In some embodiments, a spiral groove is arranged around the outer surface of the first support member, and the first helical antenna is arranged in the spiral groove.

In some embodiments, the substrate has a first through hole and a second through hole. The first end of the first helical antenna is fixed to the first through hole, and the first end of the second helical antenna is fixed to the second through hole.

In some embodiments, the substrate has a signal input element. The first end of the second helical antenna is coupled to the signal feeding terminal of the signal input element.

In some embodiments, the substrate has a ground layer serving as the ground terminal. The first end of the first helical antenna is coupled to the ground layer.

In some embodiments, the first support member has a fastening element.

In some embodiments, the substrate has a third through hole. The fastening element penetrates the third through hole to fasten on the third through hole.

In some embodiments, the height of the first support member is 3.65 mm.

In some embodiments, the diameter of the first helical antenna is 11.5 mm.

In some embodiments, the diameter of the second helical antenna is 8.5 mm.

In some embodiments, the antenna device further includes a switch disposed on the substrate. The first end of the first helical antenna is coupled to the switch, and the first end of the second helical antenna is coupled to the switch.

In some embodiments, the switch is a double pole double throw (DPDT) switch.

In some embodiments, the switch switches the first helical antenna to electrically connect to the ground terminal and the second helical antenna to electrically connect to the signal feeding terminal, or the switch switches the first helical antenna to electrically connect to the signal feeding terminal and the second helical antenna to electrically connect to the ground terminal according to a control signal.

Another embodiment of the present disclosure is to provide an electronic device, including the antenna device disclosed in the above and a switch. The switch is arranged on the substrate. The first end of the first helical antenna is coupled to the switch, and the first end of the second helical antenna is coupled to the switch. The electronic device can operate in a first mode and a second mode. When the electronic device operates in the first mode, the electronic device generates a control signal to control the switch to switch the first helical antenna electrically connected to the ground terminal and the second helical antenna electrically connected to the signal feeding terminal. When the electronic device operates in the second mode, the electronic device generates a control signal to control the switch to switch the first helical antenna electrically connected to the signal feed terminal and the second helical antenna electrically connected to the ground terminal.

In some embodiments, the switch is a double pole double throw (DPDT) switch.

Accordingly, a first helical antenna is disposed on a first support member, and a second helical antenna is disposed between the first support member and the second support member. Then, the first helical antenna and the second helical antenna are assembled on a substrate via the first support member. Because the shapes and the structures of the first helical antenna and the second helical antenna are supported by the first support member and the second support member, the shapes and the structures of the first helical antenna and the second helical antenna are hard to be deformed so as to ensure that the structural parameters of the first helical antenna and the second helical antenna can be maintained. Furthermore, by providing a double pole double throw (DPDT) switch, the antenna device can switch the coupling relationship between the first helical antenna and the second helical antenna and the signal feeding terminal and the ground terminal according to the application scenario for providing better antenna signal transmission and reception quality.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic diagram of an antenna device according to a preferred embodiment of the present disclosure.

FIG. 1B is a schematic diagram of an antenna device after being flipped 180 degrees with the X-axis as the rotation axis according to a preferred embodiment of the present disclosure.

FIG. 2A is a schematic diagram of a substrate of an antenna device according to a preferred embodiment of the present disclosure.

FIG. 2B is a schematic diagram of a substrate of an antenna device after being flipped 180 degrees with the X-axis as the rotation axis according to a preferred embodiment of the present disclosure.

FIG. 3 is a schematic diagram of an electronic device using an antenna device according to a preferred embodiment of the present disclosure.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

The shapes and structures of helical antennas are inherently easily deformed by external force. The structural parameters of the helical antenna such as the vertical separation or the pitch angle are changed when the shapes and structures of helical antenna are deformed, which may influence the quality of the signal reception and transmission of the antenna. Therefore, the antenna device of the present disclosure includes a first helical antenna and a second helical antenna. The first helical antenna is disposed on a first support member, and the second helical antenna is disposed between the first support member and the second support member. The first helical antenna and the second helical antenna are assembled on a substrate through the first support member. Therefore, a convenient and accurate method for assembling the helical antenna can be realized. Moreover, the shape and structure of the assembled helical antenna are supported by the first support member and the second support member so as to ensure that the structural parameters of the assembled helical antenna can be maintained.

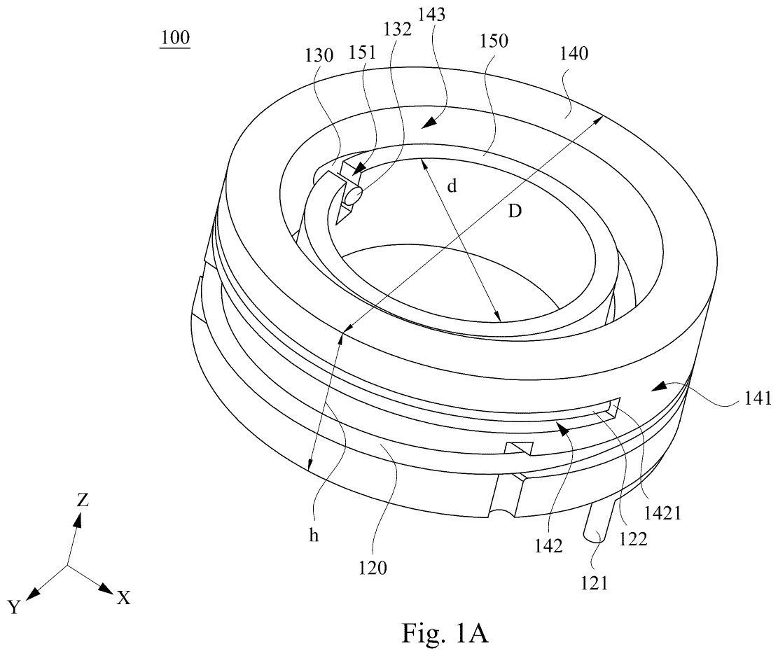

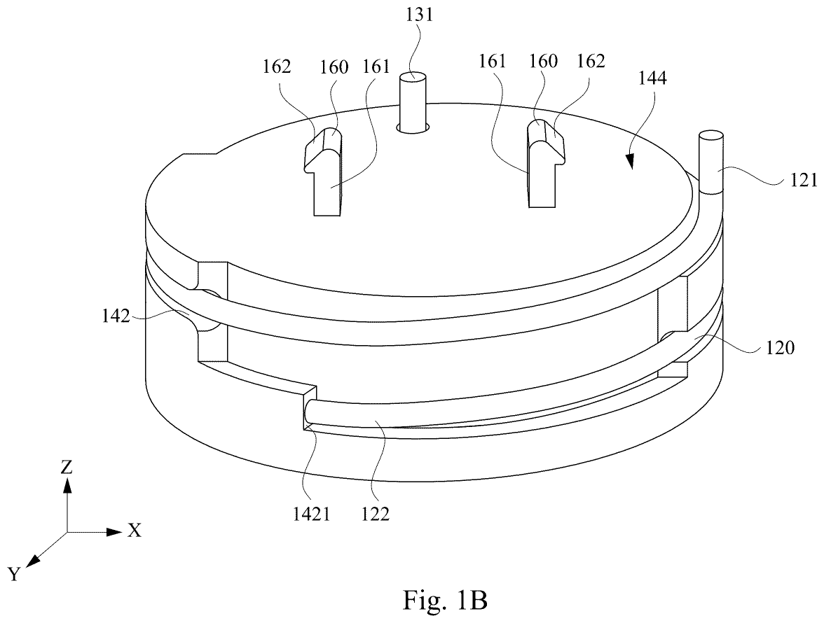

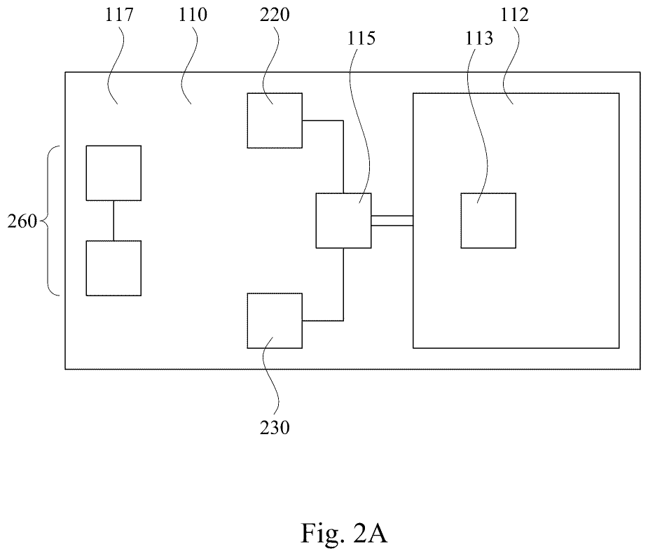

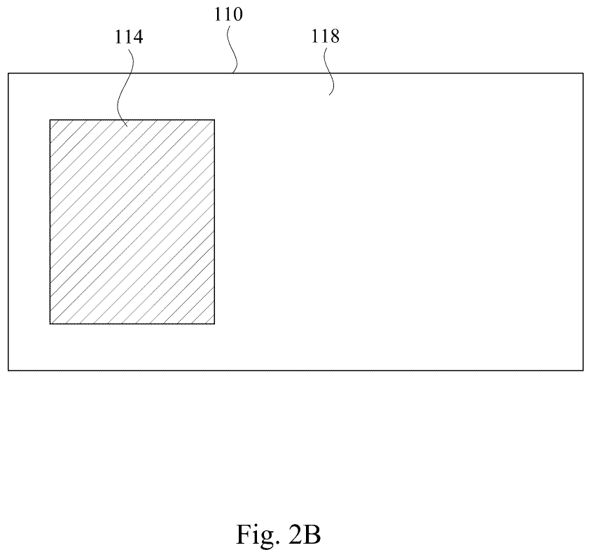

FIG. 1A is a schematic diagram of an antenna device according to a preferred embodiment of the present disclosure. FIG. 1B is a schematic diagram of an antenna device after being flipped 180 degrees with the X-axis as the rotation axis according to a preferred embodiment of the present disclosure. FIG. 2A is a schematic diagram of a substrate of an antenna device according to a preferred embodiment of the present disclosure. FIG. 2B is a schematic diagram of a substrate of an antenna device after being flipped 180 degrees with the X-axis as the rotation axis according to a preferred embodiment of the present disclosure. In some embodiments, the antenna device 100 may be assembled into an electronic device, such as a portable or vehicle-used electronic device, to transmit and receive radio frequency signals. Please refer to FIG. 1A, FIG. 1B, FIG. 2A and FIG. 2B.

In some embodiments, the antenna device 100 includes a substrate 110, a first helical antenna 120, a second helical antenna 130, a first support member 140, and a second support member 150.

In some embodiments, the first support member 140 is a cup-shaped support member. The central axis of the first support member 140 is parallel to the Z axis. The bottom surface 144 of the first support member 140 is fixed on the first surface 117 of the substrate 110. In some embodiments, the height h of the first support member 140 is about 3.65 mm, but the present disclosure is not limited thereto. In some embodiments, the second support member 150 is disposed in the first support member 140, formed along the central axis of the first support member 140, and is coaxial with the central axis of the first support member 140. In some embodiments, the first support member 140 and the second support member 150 are separated by an equal distance from each other to form a space to accommodate the second helical antenna 130. In some embodiments, the first support member 140 and the second support member 150 are formed of high molecular polymers. For example, the first support member 140 and the second support member 150 can be made by injection molding of plastic materials.

In some embodiments, the first support member 140 includes an outer surface 141 and an inner surface 143. A spiral groove 142 disposed on the outer surface 141 of the first support member 140. The first helical antenna 120 is disposed in the spiral groove 142. Because the first helical antenna 120 is disposed in the spiral groove 142, the spiral groove 142 can provide a better supporting effect for the first helical antenna 120 to maintain the shape and structure of the first helical antenna 120. In some embodiments, the diameter D of the first helical antenna 120 is about 11.5 mm, but the present disclosure is not limited thereto. In some embodiments, the second helical antenna 130 is disposed between the inner surface 143 of the first support member 140 and the second support member 150. That is, the second helical antenna 130 is disposed in a space that is formed by the inner surface 143 of the first support member 140 and the outer surface of the second support member 150 being separated by an equal distance from each other. The first support member 140 and the second support member 150 can provide the second helical antenna 130 with a better support effect to maintain the shape and structure of the second helical antenna 130. In some embodiments, the diameter d of the second helical antenna 130 is about 8.5 mm, but the present disclosure is not limited thereto.

In some embodiments, the first helical antenna 120 is generally a spiral structure. The first helical antenna 120 includes a first end 121 and a second end 122. The second end 122 is away from the substrate 110 relative to the first end 121. In some embodiments, when the first helical antenna 120 is disposed in the spiral groove 142, the second end 122 of the first helical antenna 120 may abut against a wall 1421 of the spiral groove 142 to locate the position of the first helical antenna 120. The first end 121 of the first helical antenna 120 is bent toward the substrate 110 and extends in a direction parallel to the Z-axis. In some embodiments, when the first support member 140 assembles the first helical antenna 120 and the second helical antenna 130 onto the substrate 110, the first end 121 of the first helical antenna 120 is coupled to the substrate 110 and electrically connected to a ground terminal on the substrate 110. In some embodiments, a ground layer 114 serving as the ground terminal is disposed on the second surface 118 of the substrate 110. Therefore, the first end 121 of the first helical antenna 120 is coupled to the ground layer 114 disposed on the second surface 118 of the substrate 110.

In some embodiments, the second helical antenna 130 is generally a spiral structure. The second helical antenna 130 includes a first end 131 and a second end 132. The second end 132 is away from the substrate 110 relative to the first end 131. In some embodiments, when the second helical antenna 130 is disposed between the inner surface 143 of the first support member 140 and the second support member 150, the second end 132 of the second helical antenna 130 is locked in a notch 151 of the second support member 150 to locate the position of the second helical antenna 130. The first end 131 of the second helical antenna 130 is bent toward the substrate 110 and extends in a direction parallel to the Z-axis. In some embodiments, when the first support member 140 assembles the first helical antenna 120 and the second helical antenna 130 onto the substrate 110, the first end 131 of the second helical antenna 130 is coupled to the substrate 110 and electrically connected to a signal feeding terminal 113 on the substrate 110. In some embodiments, a signal input element 112 is disposed on the first surface 117 of the substrate 110, and the first end 131 of the second helical antenna 130 is coupled to the signal feeding terminal 113 of the signal input element 112.

In some embodiments, the first support member 140 further comprises two fastening elements 160 protruding from the bottom surface 144 of the first support member 140. Two third through holes 260 respectively corresponding to the two fastening elements 160 are provided on the substrate 110. The two fastening elements 160 are capable of being respectively fastened to the two third through holes 260. In this embodiment, the number of the fastening elements 160 is two. In other embodiments, the number of the fastening element 160 can be one or can be greater than two, and, accordingly, the number of the third through holes 260, corresponding to the fastening element 160, can be one or can be greater than two. In some embodiment, the fastening element 160 comprises an extending portion 161 and a hook portion 162. The extending portion 161 has a shape of rectangular column. The hook portion 162 has a shape of triangular column. One end of the extending portion 161 is connected to the hook portion 162, and the other end of the extending portion 161 is connected to the bottom surface 144 of the first support member 140. After the extending portion 161 passes into the third through hole 260 of the substrate 110, the bottom surface 144 of the first support member 140 is against the first surface 117 of the substrate 110, and the hook portion 162 is against the second surface 118 of the substrate 110 to make the bottom surface 144 of the first support member 140 is fixed on the substrate 110.

In some embodiments, the substrate 110 includes a first surface 117 and a second surface 118. The first surface 117 and the second surface 118 are opposite to each other. A ground layer 114 is disposed on the second surface 118 of the substrate 110. A signal input element 112, a first through hole 220, a second through hole 230 and two third through holes 260 are disposed on the first surface 117 of the substrate 110. The signal input element 112 may include a signal feeding terminal 113. The signal input element 112 is composed of a variety of electronic circuit elements, such as filters, low-noise amplifiers, etc. The first through hole 220 is disposed corresponding to the first helical antenna 120. The first end 121 of the first helical antenna 120 is fixed in the first through hole 220 and passes through the first through hole 220 to couple with the ground layer 114 disposed on the second surface 118 of the substrate 110. The second through hole 230 is disposed corresponding to the second helical antenna 130. The first end 131 of the second helical antenna 130 is fixed in the second through hole 230 and coupled to a signal feeding terminal 113 of the signal input element 112. The two third through holes 260 are respectively disposed corresponding to the two fastening elements 160. The two fastening elements 160 can be respectively fastened to the two third through holes 260 to make the bottom surface 144 of the first supporting member 140 is fixed on the substrate 110.

In some embodiments, a switch 115 is further disposed on the first surface 117 of the substrate 110. The switch 115 is a double pole double throw (DPDT) switch. One end of the switch 115 is coupled to the first through hole 220 and the second through hole 230, and the other end of the switch 115 is coupled to the ground layer 114 and the signal feeding terminal 113 on the signal input element 112. Therefore, in this embodiment, the first end 121 of the first helical antenna 120 fixed in the first through hole 220 can selectively couple to the ground layer 114 or to the signal feeding terminal 113 on the signal input element 112 by the switching of the switch 115. The first end 131 of the second helical antenna 130 fixed in the second through hole 230 can also be selectively coupled to the ground layer 114 or to the signal feeding terminal 113 on the signal input element 112 by the switching of the switch 115. That is, by switching the switch 115, the first end 121 of the first helical antenna 120 is not limited to couple to the ground layer 114, and the first end 131 of the second helical antenna 130 is not limited to couple to the signal feeding terminal 113 of the signal input element 112. In other words, the antenna device 100 of the present disclosure can use a control signal to switch the switch 115 to couple the first helical antenna 120 to the ground layer 114 and the second helical antenna 130 to the signal feeding terminal 113 on the signal input element 112, or to couple the first helical antenna 120 to the signal feeding terminal 113 on the signal input element 112 and the second helical antenna 130 to the ground layer 114 according to the application scenario or installation area, so as to be suitable for the usage scenario and provide better receiving and transmitting signal quality.

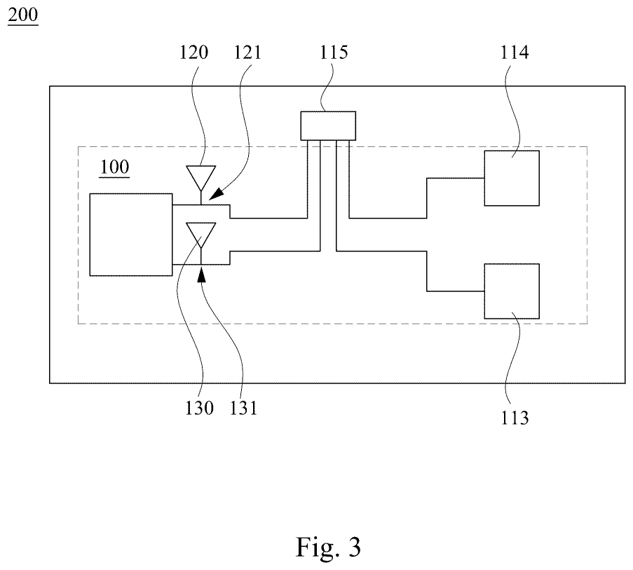

FIG. 3 is a schematic diagram of an electronic device using an antenna device according to a preferred embodiment of the present disclosure. In some embodiments, the electronic device 200 includes the antenna device 100 and the switch 115. The electronic device 200 is, for example, a portable electronic device or a car electronic device. The electronic device 200 receives GPS signals through the antenna device 100. In some embodiments, the switch 115 is a double pole double throw (DPDT) switch. The switch 115 may be disposed on the substrate 110 of the antenna device 100.

In some embodiments, the electronic device 200 has two different operating modes, a first mode and a second mode. In some embodiments, the first mode is a tablet computer mode, and the second mode is a desktop computer mode. Because the two operation modes of the electronic device 200 have different shielding effects for the antenna device 100 disposed on the electronic device 200, the switch 115 is switched to select the coupling mode for the first helical antenna 120 and the second helical antenna 130 in the antenna device 100 in order to obtain a better signal transmission and reception quality. Therefore, in some embodiments, when the electronic device 200 operates in the first mode, the electronic device 200 generates a control signal to control the switch 115 to switch the first helical antenna 120 to couple to the ground layer 114 and the second helical antenna 130 to couple to the signal feeding terminal 113. When the electronic device 200 operates in the second mode, the electronic device 200 generates a control signal to control the switch 115 to switch the first helical antenna 120 to couple to the signal feeding terminal 113 and the second helical antenna 130 to couple to the ground layer 114. It is worth noting that the above description uses the corresponding operations of the first mode and the second mode to illustrate the application of the present disclosure, but the present disclosure is not limited to the above-mentioned embodiments.

Accordingly, a first helical antenna is disposed on a first support member, and a second helical antenna is disposed between the first support member and the second support member. Then, the first helical antenna and the second helical antenna are assembled on a substrate via the first support member. Therefore, a convenient and accurate method for assembling the antenna can be provided. Moreover, because the shapes and the structures of the first helical antenna and the second helical antenna are supported by the first support member and the second support member, the shapes and the structures of the first helical antenna and the second helical antenna are hard to be deformed so as to ensure that the structural parameters of the first helical antenna and the second helical antenna can be maintained. Furthermore, by providing a double pole double throw (DPDT) switch, the antenna device can switch the coupling relationship between the first helical antenna and the second helical antenna and the signal feeding terminal and the ground terminal according to the application scenario for providing better antenna signal transmission and reception quality.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An antenna device, comprising:
a substrate;
a first helical antenna, wherein a first end of the first helical antenna is coupled to the substrate and electrically connected to a ground terminal;
a second helical antenna, wherein a first end of the second helical antenna is coupled to the substrate and electrically connected to a signal feeding terminal; and
a first support member coupled to the substrate, wherein a second support member is disposed in the first support member,
wherein the first helical antenna is disposed around an outer surface of the first support member, and the second helical antenna is disposed between an inner surface of the first support member and the second support member.

2. The antenna device as claimed in claim 1, further comprising a spiral groove disposed around the outer surface of the first support member, wherein the first helical antenna is disposed in the spiral groove.

3. The antenna device as claimed in claim 1, wherein the substrate has a first through hole and a second through hole, the first end of the first helical antenna is fixed to the first through hole, and the first end of the second helical antenna is fixed to the second through hole.

4. The antenna device as claimed in claim 3, wherein the substrate has a signal input element, and the first end of the second helical antenna is coupled to the signal feeding terminal of the signal input element.

5. The antenna device as claimed in claim 3, wherein the substrate has a ground layer serving as the ground terminal, and the first end of the first helical antenna is coupled to the ground layer.

6. The antenna device as claimed in claim 1, wherein the first support member has a fastening element.

7. The antenna device as claimed in claim 6, wherein the substrate has a third through hole, and the fastening element penetrates the third through hole to fasten on the third through hole.

8. The antenna device as claimed in claim 1, wherein a height of the first support member is 3.65 mm.

9. The antenna device as claimed in claim 1, wherein a diameter of the first helical antenna is 11.5 mm.

10. The antenna device as claimed in claim 1, wherein a diameter of the second helical antenna is 8.5 mm.

11. The antenna device as claimed in claim 1, further comprising a switch disposed on the substrate, wherein the first end of the first helical antenna is coupled to the switch, and the first end of the second helical antenna is coupled to the switch.

12. The antenna device as claimed in claim 11, wherein the switch is a double pole double throw (DPDT) switch.

13. The antenna device as claimed in claim 11, wherein the switch switches the first helical antenna to electrically connect to the ground terminal and the second helical antenna to electrically connect to the signal feeding terminal, or switches the first helical antenna to electrically connect to the signal feeding terminal and the second helical antenna to electrically connect to the ground terminal according to a control signal.

14. An electronic device, comprising:
a substrate;
a first helical antenna, wherein a first end of the first helical antenna is coupled to the substrate and electrically connected to a ground terminal;
a second helical antenna, wherein a first end of the second helical antenna is coupled to the substrate and electrically connected to a signal feeding terminal;
a first support member coupled to the substrate, wherein a second support member is disposed in the first support member,
wherein the first helical antenna is disposed around an outer surface of the first support member, and the second helical antenna is disposed between an inner surface of the first support member and the second support member; and
a switch disposed on the substrate, wherein the first end of the first helical antenna is coupled to the switch, and the first end of the second helical antenna is coupled to the switch,
wherein the electronic device operates in a first mode and a second mode,
when the electronic device operates in the first mode, the electronic device generates a control signal to control the switch to switch the first helical antenna to electrically connect to the ground terminal and the second helical antenna to electrically connect to the signal feeding terminal, and
when the electronic device operates in the second mode, the electronic device generates the control signal to control the switch to switch the first helical antenna to electrically connect to the signal feeding terminal and the second helical antenna to electrically connect to the ground terminal.

15. The electronic device as claimed in claim 14, wherein the switch is a double pole double throw (DPDT) switch.
